(19) United States
(12) Patent Application Publication
(10) Pub. No.: US 2007/0101158 A1
(43) Pub. Date: May 3, 2007

(54) Security region in a non-volatile memory

(76) Inventor: Robert C. Elliott, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/262,003

(22) Filed: Oct. 28, 2005

(51) Int. Cl. G06F 12/14

(52) U.S. Cl. 713/193

(57) ABSTRACT

In a security system, a controller is adapted to access data in a non-volatile storage and create an effectively volatile region in the non-volatile storage.

### BACKGROUND

Various types of electronic systems may be vulnerable to security breaches due to temporary storage of secret data in non-volatile storage. For example, RAID controllers often have battery-backed memory modules designed for removal. A security problem may occur if, for example, plaintext encryption keys are stored in the battery-backed, non-volatile memory modules.

### SUMMARY

In accordance with an embodiment of a security system, a controller is adapted to access data in a non-volatile storage and create an effectively volatile region in the non-volatile storage.

### BRIEF DESCRIPTION OF THE DRAWINGS

Embodiments of the invention relating to both structure and method of operation may best be understood by referring to the following description and accompanying drawings:

FIG. 1 is a schematic block diagram illustrating an embodiment of a security apparatus configured to create a volatile-type operation in a section of non-volatile memory for security purposes;

FIGS. 2A and 2B are schematic block diagrams depicting embodiments of an electronic apparatus including a non-volatile storage with one or more sections configured for volatile operation;

FIG. 3 is a schematic block diagram showing an example embodiment of a RAID controller that attains security for encryption keys by creating a volatile-type operation in a section of non-volatile memory;

FIG. 4 is a flow chart illustrating an embodiment of a method of securing data in a non-volatile memory; and

FIGS. 5A, 5B, 5C, and 5D form a set of flow charts depicting another embodiment of a security technique.

### DETAILED DESCRIPTION

Encryption software that executes on a processor typically operates with security keys and stores the keys in memory. In many conventional computers, the memory is volatile and memory content is lost when the computer is powered-off. In operating systems such as Windows, efforts are typically made to limit the amount of time a key is stored in memory so that other processes cannot accidentally or purposely detect the keys. A suitable security model takes into consideration vulnerability arising from the power-off condition.

Commonly, RAID (Redundant Array of Independent Disks) controllers have a memory that is battery-backed, therefore non-volatile, and located on a module designed for removal. Security keys stored in such a memory is a security weakness.

A memory could be split into battery-backed portions and non-battery-backed portions, but would operate on an excessively large granularity and would waste memory space. In usual configurations, most RAID controller memory usage is non-volatile, for example for storing a write cache.

To enable and facilitate a secure system, a region of non-volatile memory may be made to appear and operate as volatile by encrypting and/or decrypting memory accesses in a memory controller. For example, a RAID controller may generate a true random number using a random number generator at power-on and use the random number as a key to an encryption function. The key is not exposed to software and is lost at power-off. If an attacker inspects the non-volatile memory after the controller is powered-off or via an access by a different controller, the original random number is not available or knowable and the data in the volatile region of memory cannot be deciphered.

Accordingly, a security system and/or associated controller are described herein which encrypt and decrypt traffic to a memory region in a non-volatile storage based on a security key created at power-on and lost at power-off. The security key is not exposed. The memory region is thus made effectively volatile.

A particular embodiment may comprise a random number generator that creates a random number at power-up for usage as the security key.

The security system and/or associated controller may be adapted to enable RAID controllers to manage encryption keys and implement security algorithms.

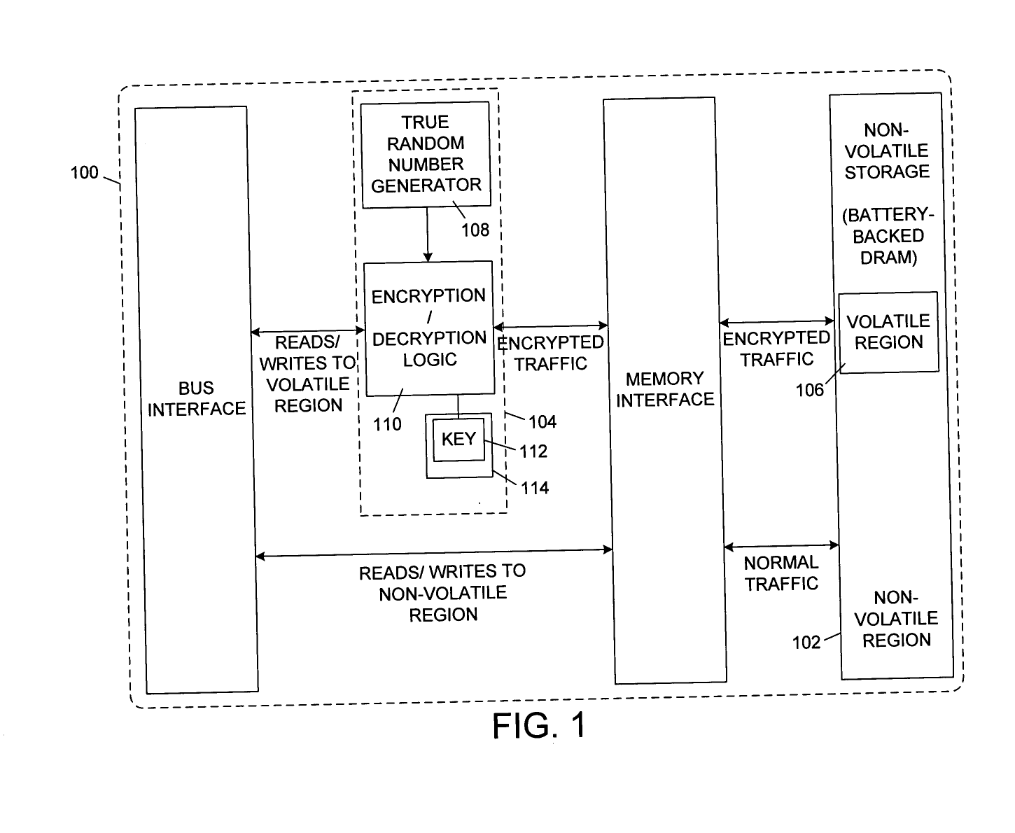

Referring to FIG. 1, a schematic block diagram illustrates an embodiment of a security apparatus 100 configured to create a volatile-type operation in a section of non-volatile memory 102 for security purposes. The illustrative security apparatus 100 comprises a non-volatile storage 102 or memory and a controller 104. The controller 104 accesses the non-volatile storage 102 and creates an effectively volatile region 106 in the non-volatile storage 102 by encrypting information written to the effectively volatile region 106 and decrypting information read from the region 106.

In a particular example, the security apparatus 100 may be implemented with a non-volatile random access memory (NVRAM) and create one or more volatile regions in the NVRAM that do not retain secured information in the event of power loss. For a security apparatus 100 that creates multiple effectively volatile regions 106, the regions may be contiguous or noncontiguous.

The illustrative controller 104 comprises a random-number generator 108 and encryption/decryption logic 110. The random number generator 108 is configured to generate an encryption/decryption key 112 for encrypting and decrypting information stored in the effectively volatile region 106. The encryption/decryption logic 110 encrypts data to be written to the effectively volatile region 106 and decrypts data read from the volatile region 106 using the encryption/decryption key 112.

In an illustrative embodiment, the random number and associated key or keys are generated at power-on and never detectable by application software or firmware.

The encryption/decryption logic 110 may be operative in combination with the controller 104 and is configured to execute a suitable symmetric encryption/decryption algorithm. Various algorithms that may be implemented include Data Encryption Standard (DES), Triple DES (3DES), extended DES (DESX), RC2 (ARCTWO), Rijndael, Advanced Encryption Standard (AES), and extensions and/or modifications of the listed standardized algorithms. In a simple embodiment, the encryption/decryption logic 110 may perform an exclusive-OR (XOR) logical operation of the data and the created random number.

The encryption/decryption key 112 is stored in a volatile storage 114 distinct from the non-volatile storage 102. For example, the controller 104 may store the encryption/decryption key 112 in a volatile storage 114 such as a register, volatile random access memory associated with the controller 104, set of flip-flops, or the like, which does not retain the key value when power to the controller 104 is terminated. Examples of the volatile storage 114 include circuit elements in a controller ASIC (Application Specific Integrated Circuit) such as registers, flip-flops, and the like.

Random number size is generally selected based on the size of the data encrypted and/or decrypted. In various security configurations, such as methods based on eXclusive-OR (XOR) operations, the encryption/decryption key 112 and data encrypted/decrypted may have a size selected based on a memory bus width and an error correction code (ECC) protection width, for example 64 bits, so that read-modify-write operations during encryption and/or decryption are reduced or minimized. In other security configurations, for example Advanced Encryption Standard (AES) and Triple Data Encryption Standard (3DES), the encryption algorithm determines block size and key size is independent of block size. The random number size may be selected, more specifically, to avoid the need for extra read-modify-write operations on writes smaller than the bus width and ECC protection width. In typical operation, the memory controller already performs some read-modify-write operations to maintain updating of the error correction code (ECC). To facilitate efficient operation, the encryption process may use the same boundaries.

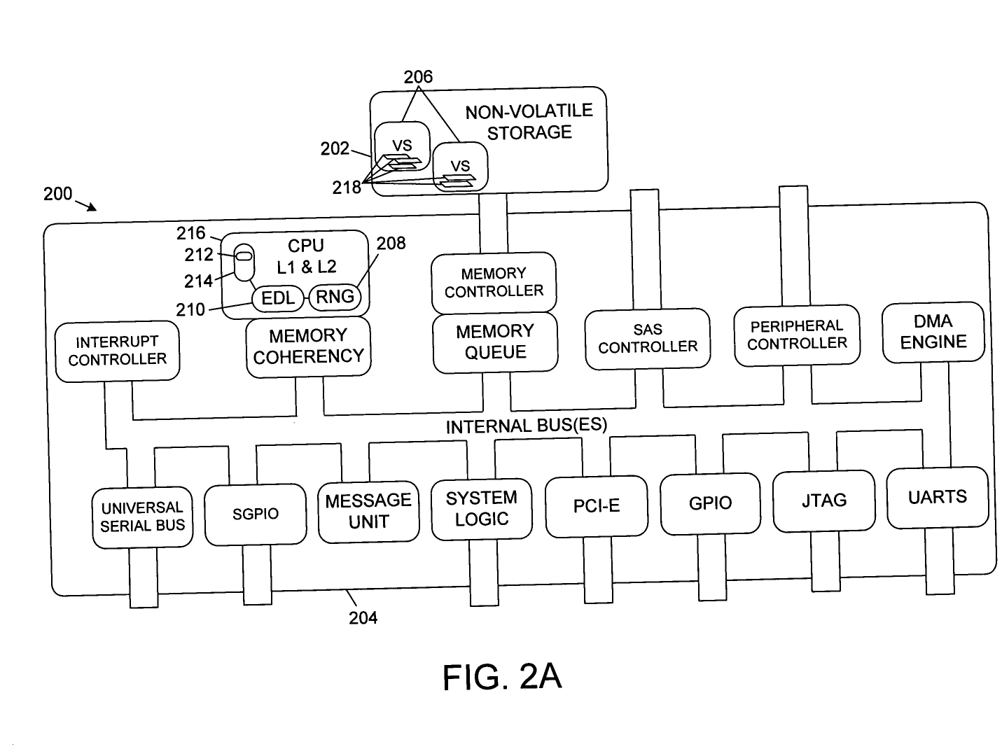

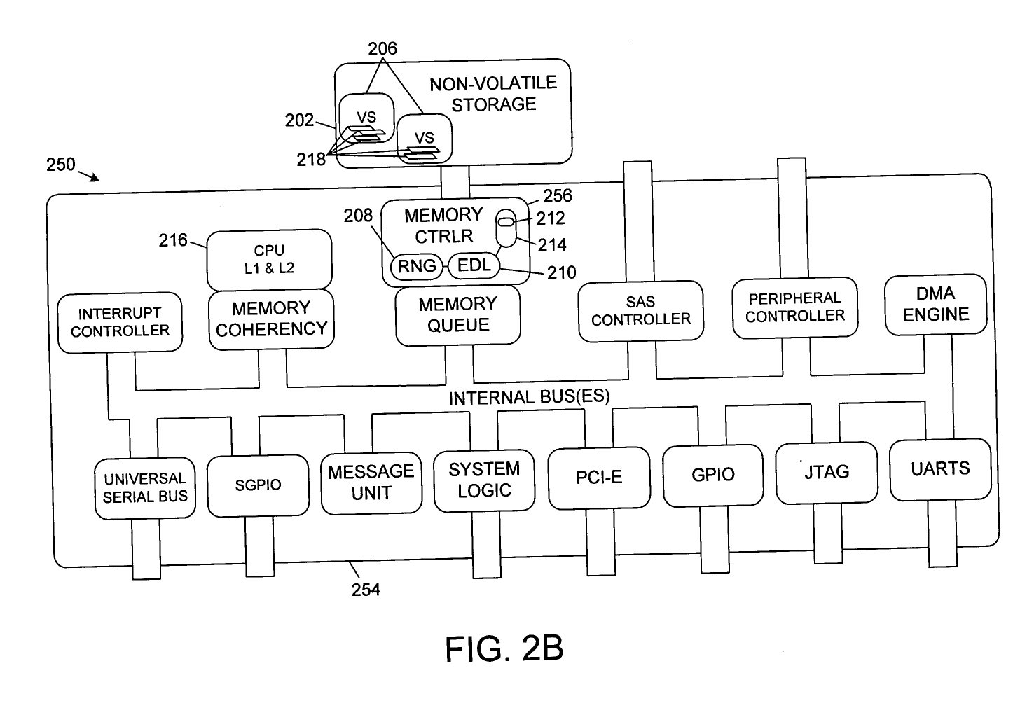

Referring to FIG. 2A, a schematic block diagram depicts an embodiment of an electronic apparatus 200 including a non-volatile storage with one or more sections configured for volatile operation. The electronic apparatus 200 comprises a controller 204 adapted to access data in a non-volatile storage 202 and create an effectively volatile region 206 in the non-volatile storage 202. The controller 204 creates volatile functionality in the non-volatile storage 202 by encrypting data written to the effectively volatile region 206 and decrypting data read from the region 206.

The illustrative controller 204 includes a central processing unit (CPU) 216 with level 1 (L1) and level 2 (L2) caches. The CPU 216 may incorporate a random number generator 208 and encryption/decryption logic 210. The random number generator 208 generates a random number which is used by the encryption/decryption logic 210 to create an encryption key 212 for usage in encrypting data to be stored in the effectively volatile region 206. The encryption key 212 is stored in a volatile storage 214 associated with the controller 204 that is lost when power is removed so that generation of a new encryption key 212 is executed on power-up. In typical implementations, the volatile region 214 may be registers or flip-flops in a component such as the CPU 216 or other suitable functional block.

A non-volatile storage 202 is coupled to the controller 204 with the controller 204 adapted to manage the non-volatile storage 202 to create one or more effectively volatile regions 206 in the non-volatile storage 202.

In a particular illustrative embodiment, the electronic apparatus 200 may be used to create a volatile operational character in non-volatile storage 202, such as non-volatile random access memory (NVRAM), for security purposes. For example, in a RAID (Redundant Array of Independent Disks) controller 200 with non-volatile memory 202, a region of the non-volatile memory 202 is operated to function as a volatile storage 206 for storage of encryption keys 218.

The controller 204 may be configured to ensure that any storage of an encryption key in memory is directed to a volatile address region. The controller 204 may also store other volatile data in the effectively volatile region 206, for example additional data structures used in the vicinity of key storage. In an example implementation, the effectively volatile region 206 may have the same access semantics as normal non-volatile memory 202.

The implemented encryption algorithm may be either simple or complex. A simple encryption algorithm may be implemented as a simple exclusive-OR (XOR) of the data for encryption with a generated random number, a technique that is both simple and fast. A potential weakness of the simple technique is susceptibility to an attacker able to select data stored in the effectively volatile region. For example, if the attacker stores all zeros, or any known pattern, to the effectively volatile region, the result written in memory is the random number, or a decipherable number. If logic, such as software operating in the controller, is protected so that an attacker cannot control what is stored, the risk may be made acceptable.

Risk may be further reduced by limiting a particular effectively volatile region to storage of security keys and limiting access to that region accordingly.

A more complex encryption technique may use any symmetric encryption algorithm such as Data Encryption Standard (DES), Triple DES (3DES), extended DES (DESX), RC2 (ARCTWO), Rijndael, Advanced Encryption Standard (AES), extensions and/or modifications of the listed standardized algorithms, and others. A suitable complex algorithm may implement the electronic codebook (ECB) block cipher mode. The complex encryption techniques attain security even if an attacker can select the data to be encrypted. ECB mode avoids any dependence on adjacent blocks. A disadvantage of the more complex techniques is a reduction in speed since algorithms typically process the data through approximately ten to fourteen rounds, making accesses substantially slower in the effectively volatile regions than in the remainder of the non-volatile storage.

The complex encryption approach is most secure if only security keys are stored in the effectively volatile region and the number of data structures in the effectively volatile memory restricted or limited.

The system and technique that create an effectively volatile region in non-volatile memory may be implemented in combination with other security measures. For example, a controller may include security measures that restrict usage of debuggers on JTAG (Joint Test Action Group) ports, detect and inhibit downloading of rogue software and exploitation of code bugs, and the like. Accordingly, creation of an effectively volatile region of non-volatile memory may be one part of a comprehensive security system.

Various design rules and/or guidelines may be included in a secure design. For example, design rules may impose a condition that only the CPU 216 be enabled to access the effectively volatile region 206. If DMA (direct memory access) engines or PCI (peripheral component interconnect) cores are allowed access to the region 206, arbitrary data could be stored that would expose the security key in XOR (exclusive-OR) mode.

Other design rules may include prohibition against writing particular initialization patterns to the region 206. For example, the writing of logic zeros to initialize the ECC (error correction code) bytes may be prohibited to avoid exposure of the security key in XOR (exclusive-OR) mode.

The illustrative electronic apparatus 200 may be implemented as a RAID on a chip (ROC) ASIC (Application Specific Integrated Circuit) and may be arranged with one or more components such as an interrupt controller, a USB (Universal Serial Bus) interface, the Central Processing Unit (CPU) 216, and a memory coherence element. The electronic apparatus 200 may further include memory control components such as a memory controller and memory queue. Control elements may be included such as a Serial Attached SCSI (SAS) controller, a peripheral controller, a message unit, and system logic. Communication elements may include a Direct Memory Access (DMA) engine, one or more UART (Universal Asynchronous Receiver Transmitter) devices, a General Purpose Input Output (GPIO) element, a Serial GPIO (SGPIO) element. Interfaces may also include a Peripheral Component Interconnect-Express (PCI-E) element.

Referring to FIG. 2B, a schematic block diagram illustrates another embodiment of an electronic apparatus 250 that includes a non-volatile storage 202 with one or more sections 206 configured for volatile operation. In various embodiments, control logic in a controller 254 may be implemented in any suitable functional element. The illustrative controller 254 includes a memory controller 256 which may incorporate a random number generator 208 and encryption/decryption logic 210. The random number generator 208 generates a random number which is used by the encryption/decryption logic 210 to create an encryption/decryption key 212 for usage in encrypting and decrypting data.

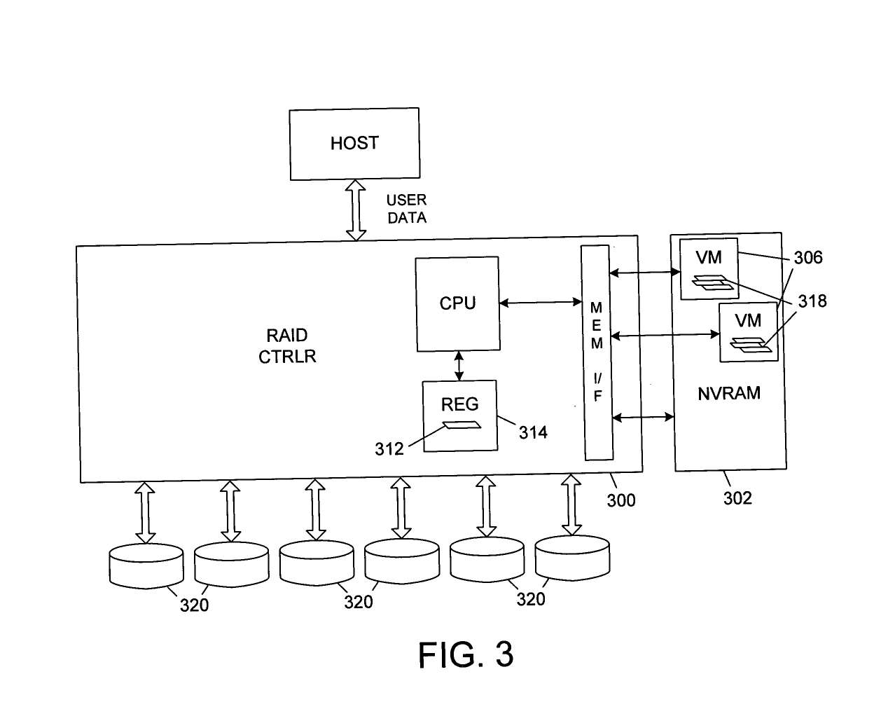

Referring to FIG. 3, a schematic block diagram shows an example embodiment of a RAID controller 300 that attains security for encryption keys by creating a volatile-type operation in a section 306 of non-volatile memory 302 for security purposes.

The RAID controller 300 is often configured to manage a large number of disk drives 320, for example hundreds of drives 320. The RAID controller 300 may also manage tape drives or other storage devices. In an example embodiment, a RAID controller 320 may allocate one encryption key per disk drive although other implementations are possible. Conventionally, encryption keys have generally been stored in volatile register space so that, with evolution of larger and larger RAID systems and development of more secure encryption algorithms with larger encryption keys (for example, 64 bits for DES, 256 bits for AES), sufficient register space is unavailable. One scheme for increasing storage available for RAID-level encryption keys involves storing keys on a larger memory, for example a dynamic RAM (DRAM) made non-volatile by including batteries on the memory module.

A potential security breach in such RAID controllers is that DRAM may be battery-backed and associated with a cache module that is removable by the customer. Unless encrypted, the keys stored in the DRAM are unprotected from security breach.

The illustrative RAID controller 300 attains security by encrypting RAID-level encryption keys 318 stored in the battery-backed DRAM 302. An encryption key 312 which is used to encrypt and decrypt the RAID-level encryption keys 318 may be stored in a register 314 associated with a control logic 304.

The RAID controller 300 employs two levels of security keys: (1) RAID-level keys 318 for encrypting data on the disks or tapes which are stored on the DRAM 302, and (2) keys 312 stored in volatile register 314 on the ASIC for encrypting the RAID-level keys 318 stored in the DRAM 302.

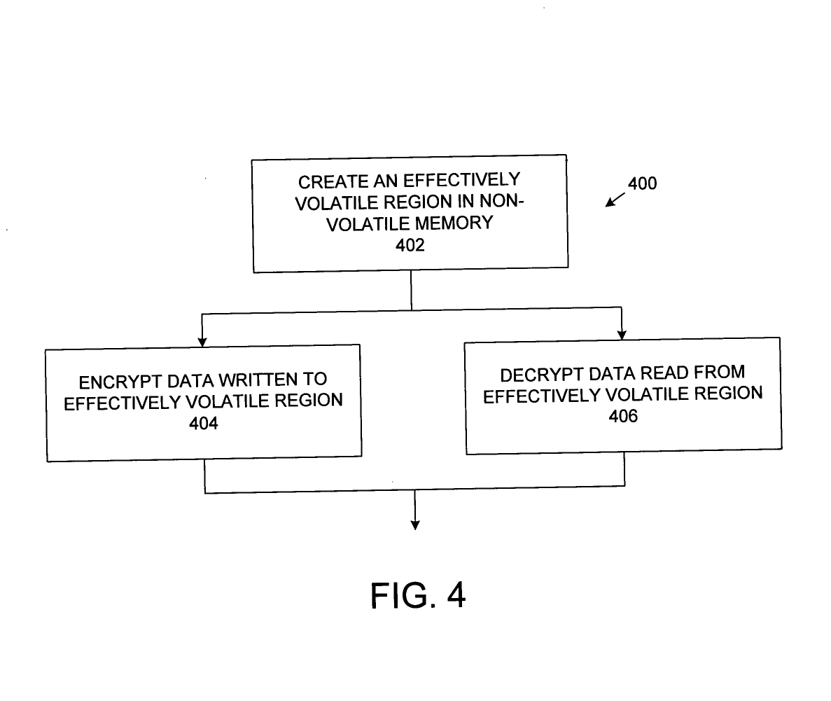

Referring to FIG. 4, a flow chart illustrates an embodiment of a method 400 of securing data in a non-volatile memory. The method 400 comprises creating 402 an effectively volatile region in a non-volatile memory. Data written to the effectively volatile region is encrypted 404 and data read from the effectively volatile region is decrypted 406.

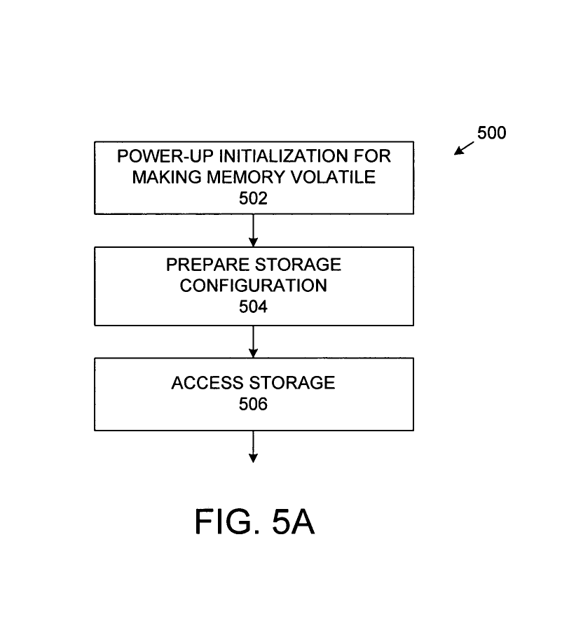

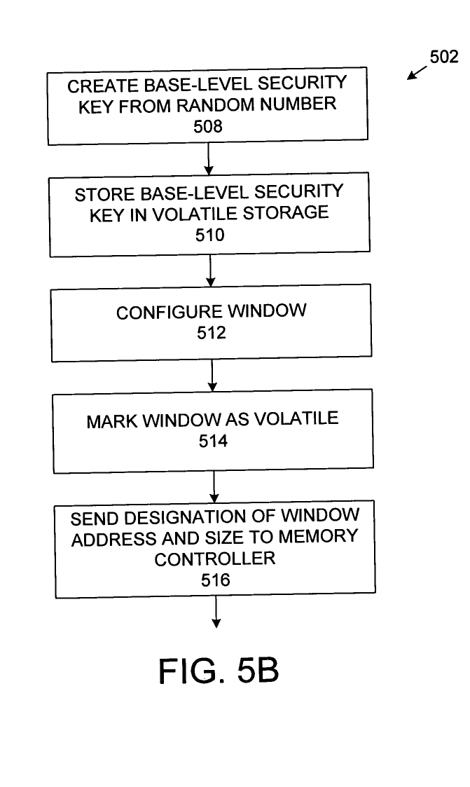

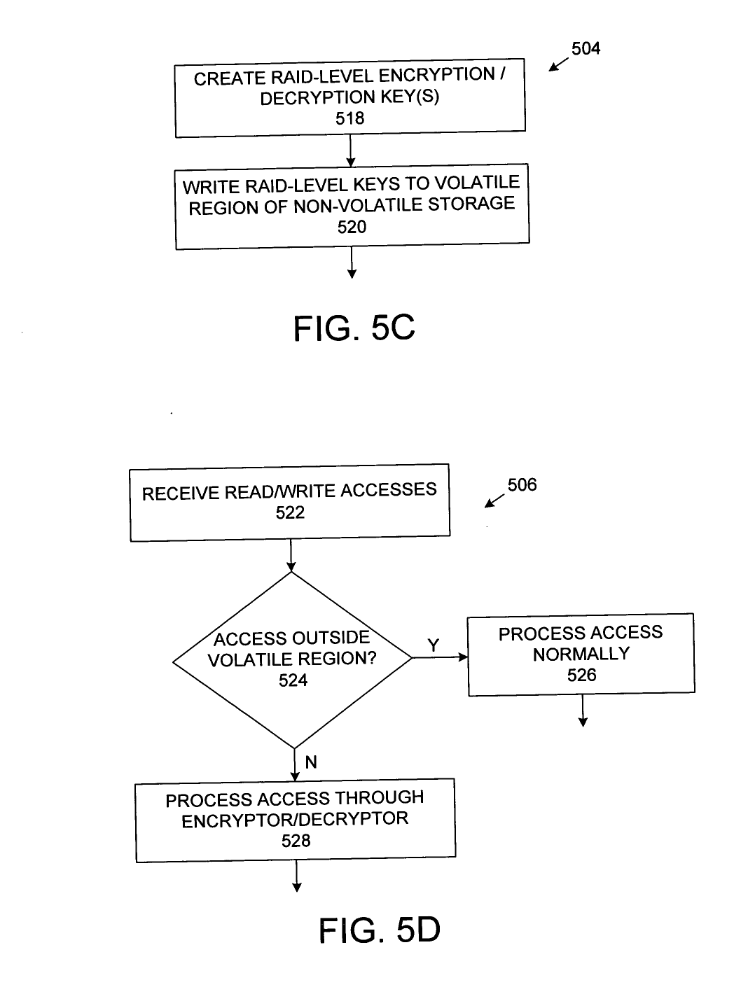

Referring to FIGS. 5A, 5B, 5C, and 5D, a set of flow charts illustrate another embodiment of a security technique 500. The security method 500 comprises three stages shown in FIG. 5A. A first stage 502 executes during power-up to create an encryption key, termed a “volatilizing” key and stores the key in a register in an ASIC. A second stage 504 executes during storage configuration which occurs during power-up and also may take place when storage is modified, for example when additional storage is connected to the system. In the second stage 504, RAID-level encryption keys for accessing a particular disk drive or tape drive are created and stored in a non-volatile storage (NVRAM). A third stage 506 executes during disk accesses and tape drive accesses to encrypt and decrypt data passing to and from the disk drives and tape drives.

At power-up and execution of the first stage 502 shown in FIG. 5B, an effectively volatile region in a non-volatile memory. For example, a base-level security key, also called an encryption key, is created 508 using a random number generator. The encryption key is stored 510 in a volatile storage, such as a register on one of the ASICs. Accordingly, the encryption key is held in a volatile storage distinct from the non-volatile storage. The controller configures 512 a window in the main memory system non-volatile storage and marks 514 the window as volatile. The window is configured 512, for example, by selecting a memory address and window size. In an illustrative embodiment, the configuration of the effectively volatile window including designation of the address and size are sent 516 to a memory controller.

In the storage configuration stage 504 shown in FIG. 5C executing at power-up or upon addition or removal of disk drives, tape drives, or tape cartridges from the system, RAID-level encryption/decryption keys are created 518 for the selected storage using the base-level encryption key. In various implementations, RAID-level encryption/decryption keys may be allocated to particular disks, disk groups, disk segments, tape drives, tape cartridges, or tape cartridge segments. The encryption keys may be allocated on a physical or virtual storage basis. The RAID-level encryption/decryption keys are written 520 to the effectively volatile region of the non-volatile storage.

In the third or RAID execution stage 506 depicted in FIG. 5D, information is encrypted and/or decrypted 524 using an appropriate encryption/decryption key or keys. For example, as the memory controller receives 522 read and write accesses, if the access is outside 524 the effectively volatile region of the non-volatile storage, the memory access operates normally 526. Otherwise, the access is inside the effectively-volatile region and the access is processed through the encryptor/decryptor 528, encrypting for data writes and decrypting for data reads.

The various functions, processes, methods, and operations performed or executed by the system can be implemented as programs that are executable on various types of processors, controllers, central processing units, microprocessors, digital signal processors, state machines, programmable logic arrays, and the like. The programs can be stored on any computer-readable medium for use by or in connection with any computer-related system or method. A computer-readable medium is an electronic, magnetic, optical, or other physical device or means that can contain or store a computer program for use by or in connection with a computer-related system, method, process, or procedure. Programs can be embodied in a computer-readable medium for use by or in connection with an instruction execution system, device, component, element, or apparatus, such as a system based on a computer or processor, or other system that can fetch instructions from an instruction memory or storage of any appropriate type. A computer-readable medium can be any structure, device, component, product, or other means that can store, communicate, propagate, or transport the program for use by or in connection with the instruction execution system, apparatus, or device.

The illustrative block diagrams and flow charts depict process steps or blocks that may represent modules, segments, or portions of code that include one or more executable instructions for implementing specific logical functions or steps in the process. Although the particular examples illustrate specific process steps or acts, many alternative implementations are possible and commonly made by simple design choice. Acts and steps may be executed in different order from the specific description herein, based on considerations of function, purpose, conformance to standard, legacy structure, and the like.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims. For example, although the illustrative structures and techniques are described in a RAID implementation for securing encryption keys, any suitable application for securing any appropriate type of data may be implemented. Similarly, the disclosed connector and insertion tools may be adapted for usage with any appropriate types of electronics or computer systems.

What is claimed is:

1. A security apparatus comprising:
a non-volatile storage; and
a controller adapted to couple to the non-volatile storage and create an effectively volatile region in the non-volatile storage by encrypting information written to the effectively volatile region and decrypting information read from the effectively volatile region.

2. The security apparatus according to claim 1 further comprising:
the controller adapted to encrypt and decrypt information using an encryption/decryption key that is stored in a volatile storage distinct from the non-volatile storage.

3. The security apparatus according to claim 1 further comprising:
a random number generator coupled to the controller and adapted to generate an encryption/decryption key for encrypting and decrypting information stored in the effectively volatile region.

4. The security apparatus according to claim 1 further comprising:
a random-number generator adapted to generate an encryption/decryption key for encrypting and decrypting information stored in the effectively volatile region; and
an encryption/decryption logic coupled to the random number generator that encrypts data to be written to the effectively volatile region and decrypts data read from the effectively volatile region using the encryption/decryption key.

5. The security apparatus according to claim 1 further comprising:
an encryption/decryption logic coupled operative in combination with the controller and adapted to execute a symmetric encryption/decryption algorithm selected from among a group consisting of Data Encryption Standard (DES), Triple DES (DES3), extended DES (DESX), RC2 (ARCTWO), Rijndael, Advanced Encryption Standard (AES), and an exclusive-OR (XOR) of data with a random number.

6. The security apparatus according to claim 1 further comprising:
a random number generator coupled to the controller and adapted to generate an encryption/decryption key having a bit-size selected based on characteristics selected from among size of data encrypted/decrypted, memory bus width, and/or error correction code (ECC) protection width whereby read-modify-write operations during encryption and/or decryption are reduced or minimized.

7. An article of manufacture comprising:
a controller usable medium having a computable readable program code embodied therein adapted to secure data in a non-volatile memory, the computable readable program code further comprising:
a code adapted to cause the controller to create an effectively volatile region in the non-volatile storage;
a code adapted to cause the controller to encrypt information written to the effectively volatile region; and
a code adapted to cause the controller to decrypt information read from the effectively volatile region.

8. The article of manufacture according to claim 7 further comprising:
a code adapted to cause the controller to create an encryption/decryption key; and
a code adapted to cause the controller to store the encryption/decryption key in a volatile storage distinct from the non-volatile storage.

9. The article of manufacture according to claim 7 further comprising:
a code adapted to cause the controller to generate a random number;
a code adapted to cause the controller to create an encryption/decryption key as a function of the random number; and
a code adapted to cause the controller to encrypt and/or decrypt information using the encryption/decryption key.

10. The article of manufacture according to claim 7 further comprising:
a code adapted to cause the controller to execute a symmetric encryption/decryption algorithm selected from among a group consisting of Data Encryption Standard (DES), Triple DES (DES3), extended DES (DESX), RC2 (ARCTWO), Rijndael, extended DES (DESX), Advanced Encryption Standard (AES), and an exclusive-OR (XOR) of data with a random number.

11. The article of manufacture according to claim 7 further comprising:
a code adapted to cause the controller to generate an encryption/decryption key having a bit-size selected based on a memory bus width and an error correction code (ECC) protection width whereby read-modify-write operations during encryption and/or decryption are reduced or minimized.

12. An electronic apparatus comprising:
a controller adapted to access data in a non-volatile storage and create an effectively volatile region in the non-volatile storage by encrypting data written to the effectively volatile region and decrypting data read from the effectively volatile region.

13. The electronic apparatus according to claim 12 further comprising:
a random number generator adapted to generate a random number; and
an encryption/decryption logic coupled to the random number generator and adapted to create an encryption/decryption key as a function of the generated random number and encrypt and decrypt data using the encryption/decryption key.

14. The electronic apparatus according to claim 12 further comprising:
a non-volatile storage coupled to the controller, the controller adapted to manage the non-volatile storage to create one or more effectively volatile regions in the non-volatile storage by encrypting and decrypting data accessed in the effectively volatile regions.

15. The electronic apparatus according to claim 12 further comprising:
a RAID (Redundant Array of Independent Disks) controller adapted to cause a region of non-volatile storage to appear and operate as volatile memory by encrypting accesses; and
one or more disk drives and/or tape drives, the RAID controller further adapted to store encryption/decryption keys in the apparently volatile memory for accessing the disk drives and/or tape drives.

16. The electronic apparatus according to claim 12 further comprising:
a RAID (Redundant Array of Independent Disks) controller adapted to generate a random number using a random number generator at power-on and use the random number as a key to an encryption function, the key being lost at power-off, the random number being selected from among a group comprising a generic random number, a true random number, and a pseudo-random number.

17. A method of securing data in a non-volatile memory comprising:
creating an effectively volatile region in a non-volatile memory;
encrypting data written to the effectively volatile region; and
decrypting data read from the effectively volatile region.

18. The method according to claim 17 further comprising:
creating an encryption/decryption key; and
holding the encryption/decryption key in a volatile storage distinct from the non-volatile storage.

19. The method according to claim 17 further comprising:
generating a random number;
creating an encryption/decryption key as a function of the random number; and
encrypting and/or decrypting data using the encryption/decryption key.

20. The method according to claim 17 further comprising:
generating an encryption/decryption key having a bit-size selected based on characteristics selected from among size of data encrypted/decrypted, memory bus width, and/or error correction code (ECC) protection width whereby read-modify-write operations during encryption and/or decryption are reduced or minimized.
